(19) United States
(12) Patent Application Publication
(10) Pub. No.: US 2005/0029180 A1
(43) Pub. Date: Feb. 10, 2005

(54) Strainer device for fuel tank

(75) Inventors: Toshihide Kimisawa, Yokohama-shi (JP); Takashi Iwamoto, Machida-shi (JP)

Correspondence Address: HAUPTMAN KANESAKA & BERNER, Suite 300, 1700 Diagonal Road, Alexandria, VA, 22314, US

(73) Assignee: NIFCO INC.

(21) Appl. No.: 10/889,109

(22) Filed: Jul. 13, 2004

(30) Foreign Application Priority Data
Aug. 8, 2003 (JP) 2003-289595

(51) Int. Cl. B01D 29/00

(52) U.S. Cl. 210/172; 210/416.4; 210/461; 210/486

(57) ABSTRACT

A strainer device for a fuel tank includes a suction passage member having a passage port opened in the fuel tank; a filtering member disposed to the suction passage member to cover an opening of the passage port; and a conduit connecting member extending outside the fuel tank to be connected to a conduit pipe for guiding fuel passing through the filtering member. The filtering member has a bag shape made of a soft material. The suction passage member includes a projecting portion or strainer holding member to be inserted into the filtering member for maintaining a stretched state thereof in the fuel tank. The projecting portion includes a plurality of plate-shape members extending along an axis of a passage port.

### BACKGROUND OF THE INVENTION AND RELATED ART STATEMENT

The invention relates to a strainer device for a fuel tank, and particularly relates to a strainer device suitable for a fuel tank of an automobile and a motorcycle.

A strainer device is attached to a fuel tank for removing dust and impurities from fuel. A connecting port of a pipe is formed on a bottom of the fuel tank for guiding fuel to a combustion engine, and the strainer device is inserted into the fuel tank through the connecting port as disclosed in Japanese Utility Model Publication (Kokai) No. 53-154916.

When a movable body such as an automobile and a motorcycle swivels and the body is inclined, a liquid surface in the fuel tank moves. Therefore, when the fuel strainer is inserted in the tank in an upright state relative to an inner surface of a bottom of the fuel tank, as disclosed in Japanese Utility Model Publication (Kokai) No. 53-154916, the fuel strainer directly receives a pressure of fuel moving in the tank.

The fuel strainer for filtering fuel in the automobile is required to have a relatively large surface area to satisfy demands for a low fluid resistance and a high trapping ability for dust and impurities. In other words, the fuel strainer is required to maintain a stretched state in the fuel while receiving a pressure of fuel. Accordingly, a supporting portion of the fuel strainer needs to have a special structure, thereby increasing cost.

In view of the above problems, an object of the invention is to provide a strainer device for a fuel tank capable of maintaining a stretched state thereof while standing a pressure of fuel in a fuel tank without a complex structure.

Further objects and advantages of the invention will be apparent from the following description of the invention.

### SUMMARY OF THE INVENTION

According to the present invention, a strainer device for a fuel tank includes a suction passage member having a passage port opened in a fuel tank; a filtering member disposed to the suction passage member to cover an opening of the passage port; and a conduit connecting member (hose port) extending outside the fuel tank to be connected to a conduit pipe (rubber tube) for guiding fuel passing through the filtering member. The filtering member has a bag shape made of a soft material. The suction passage member includes a projecting portion (strainer holding member) to be inserted into the filtering member for maintaining a stretched state thereof in the fuel tank. The projecting portion includes a plurality of plate-shape members extending along an axis of a passage port.

In the present invention, the projecting portion having a plurality of plate shape members is inserted into the filtering member made of a soft material for maintaining the filtering member in an expanded state in the fuel tank. Accordingly, it is possible to increase strength relative to a pressure of fuel moving in the fuel tank without a complex structure. The plate shape members extend as rectifying plates in the filtering member along an axis of the passage port through which fuel passes, thereby guiding fuel effectively.

### BRIEF DESCRIPTION OF THE DRAWINGS

FIG. 1 is a vertical sectional view showing a strainer device according to an embodiment of the invention, and

FIG. 2 is a perspective view showing a part of the strainer device disposed in a fuel tank with a filtering member partially removed according to an embodiment of the invention.

### DETAILED DESCRIPTION OF PREFERRED EMBODIMENTS

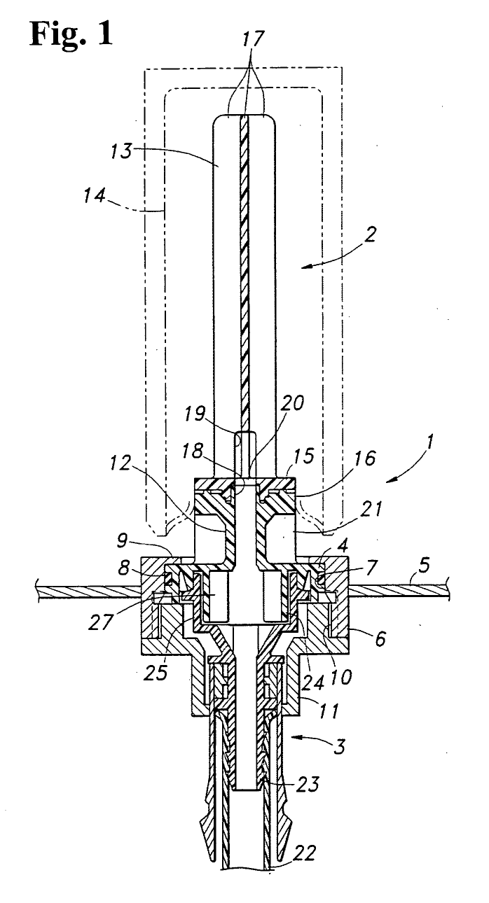

Hereunder, embodiments of the present invention will be described in detail with reference to the accompanying drawings. FIG. 1 shows a strainer device according to an embodiment of the invention. A strainer device 1 is formed of a tank inner portion 2 and a tank outer portion 3, and is made of a synthetic resin.

A base end portion 4 of the tank inner portion 2 is fitted to a reduced diameter portion 7 of a socket member 6 fixed to a bottom of a tank 5 from an outside of the fuel tank 5 in a liquid-tight sealed state through an O-ring 8, and abuts against an inward flange 9 formed at an inner end of the socket member 6 for positioning. Also, the base end portion 4 of the tank inner portion 2 is sandwiched between the inward flange 9 of the socket member 6 and an end surface of a plug member 11 by screwing the plug member 11 in a female screw 10 of the socket member 6. Accordingly, the strainer device 1 is fixed to the bottom of the fuel tank 5.

The tank inner portion 2 further includes a suction passage member 12, a strainer holding member 13 and a filtering member 14. The suction passage member 12 and the strainer holding member 13 are provided with outward flanges 16 and 15 at opposing ends thereof, respectively. The filtering member 14 has a rectangular bag shape. The strainer holding member 13 is covered with the bag-shape filtering member 14, and an opening end of the filtering member 14 is sandwiched and welded between the outward flanges 15 and 16, so that the suction passage member 12, the strainer holding member 13 and the filtering member 14 are integrated.

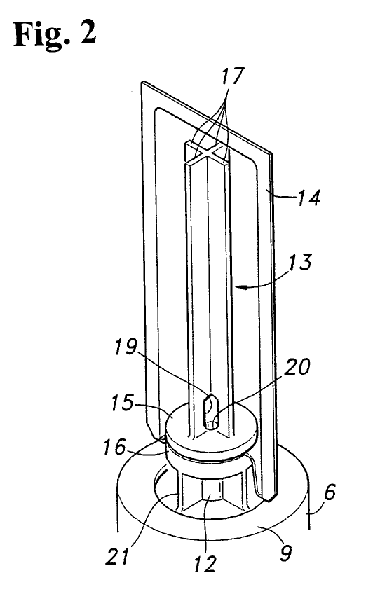

As shown in FIG. 2, the strainer holding member 13 includes four elongated plate-shape members 17 extending in a direction perpendicular to the outward flange 15 such that a section thereof has a cross shape crossing a center axis of the outward flange 15. The suction passage member 12 includes a passage port 18 disposed coaxially with the central axis of the outward flange 15 and extending from a base of the strainer holding member 13 to a base end portion 4 fitted in a socket member 6. Cut-off portions 19 are provided at end portions of the four plate-shape members 17 forming the strainer holding member 13 bonded to the outward flange 15 at mutually bonded cross portions, respectively, so that a communicating port 20 connected to the passage port 18 is formed. Reinforcing ribs 21 are formed along a circumferential direction with an equal interval between the outward flange 16 and the base end portion 4 of the suction passage member 12 for increasing rigidity of the suction passage member 12.

The filtering member 14 has a bag shape formed by welding an outer peripheral edge thereof. The bag shape filtering member 14 has a double-layer structure obtained through overlapping a plain fabric, twilled fabric or matted fabric of synthetic resin fibers on a non-woven fabric of synthetic resin fibers after spot-welding with an appropriate interval therebetween so that the double-layer bag does not separate. The bag shape filtering member 14 covers the entire strainer holding member 13. Incidentally, since the strainer holding member 13 is inserted into fuel, for example, gasoline, from the bottom of the fuel tank 5, the flexible filtering member 14 is held by the strainer holding member 13 having high rigidity and a section of a cross shape so that the flexible filtering member 14 is maintained in an expanded shape in fuel.

As described above, the filtering member 14 has a large contact area with respect to gasoline so that resistance of gasoline passing through the filtering member 14 is reduced and impurities are captured effectively. Also, the four plate-shape members 17 forming the strainer holding member 13 are disposed in the filtering member 14 with an equal angle and extend in parallel to an axis of the passage port 18. The communicating ports 20 connected to the passage port 18 are opened between the plate-shape members 17. Therefore, the plate-shape members 17 function as rectifying plates so that gasoline flows smoothly in the passage port 18.

Incidentally, the filtering member 14 is not limited to the double-layer bag formed of the woven fabric and the non-woven fabric. In order to maintain the shape, a basket-shape member (not shown) formed of a mesh through an injection molding may be combined. If necessary, a woven fabric, non-woven fabric and basket shape member may be appropriately combined, or just one of them may be employed. Especially, when the filtering member 14 is formed of a flexible material as described above, the filtering member 14 can be inserted into the tank even if the inward flange 9 formed on the socket 6 has a small inner diameter.

Also, the opening end of the bag-shape filtering member 14 is sandwiched and welded between the suction passage member 12 and the strainer holding member 13. Alternatively, it is possible that the suction passage member 12 and the strainer holding member 13 are integrally molded and taken out while a sheet-shape filtering member is inserted therein. Then, the sheet-shape filtering member is folded at a joint portion between the suction passage member 12 and the strainer holding member 13 to wrap the strainer holding member 13, and three circumferential sides of the filtering member are welded to form the tank inner portion 2.

The tank outer portion 3 is provided with a hose port 23, for example, a rubber tube 22, for fitting therein. On connecting surfaces of the tank inner portion 2 and the tank outer portion 3, there are formed cylindrical portions 24 and 25 having different diameters so that the tank inner portion is surrounded by the tank outer portion from the outer side. The cylindrical portion 24 is fitted into the cylindrical portion 25 and welded together to thereby integrate the tank inner portion 2 and the tank outer portion 3.

A plurality of radial ribs 27 is formed inside the cylindrical portion 24 at a side of the tank inner portion 2. The radial ribs 27 increase rigidity of the base end portion 4 fixed to the bottom of the fuel tank 5, and improve a rectification effect of fuel flowing in the hose opening 23.

As described above, according to the invention, the strainer device for the fuel tank can withstand a pressure of fuel in a fuel tank and maintains an expanded state without a complex structure. Accordingly, the strainer device for the fuel tank is useful for a movable body, such as an automobile and a motorcycle.

The disclosure as disclosed in Japanese Patent Application No. 2003-289595 filed on Aug. 8, 2003 is incorporated herein.

While the invention has been explained with reference to the specific embodiments of the invention, the explanation is illustrative and the invention is limited only by the appended claims.

1. A strainer device for a fuel tank, comprising:
a suction passage member having a passage port with an opening to be disposed in the fuel tank,
a filtering member attached to the suction passage member to cover the opening of the passage port, said filtering member having a bag shape formed of a soft material,
a projecting portion attached to the suction passage member and disposed in the filtering member for maintaining the filtering member in an expanded state in the fuel tank, said projecting portion including a plurality of plate-shape members extending along an axis of the passage port, and
a conduit connecting member attached to the suction passage member and extending outside the fuel tank to be connected to a conduit pipe for guiding fuel passing through the filtering member.

2. A strainer device for a fuel tank according to claim 1, wherein said plurality of plate-shape members is disposed along a periphery of the opening at positions with a substantially equal interval.

3. A strainer device for a fuel tank according to claim 2, wherein said projecting portion further includes a flange at one side connected to the suction passage member, and a center passage communicating with the passage port of the suction passage.

4. A strainer device for a fuel tank according to claim 3, wherein said projecting portion further includes cut-out portions in a center of the plate-shape members communicating with the center passage.
